(19) United States
(12) Patent Application Publication
(10) Pub. No.: US 2006/0144170 A1
(43) Pub. Date: Jul. 6, 2006

(54) Method and apparatus for detecting surveillance devices

(76) Inventors: Andrew Barry Stephen, Northhampton (GB); Ian Roberts, Northamptonshire (GB); Ian Richard Powell, Milton Keynes (GB); Steven John Holmes, Leicestershire (GB)

Correspondence Address: BROMBERG & SUNSTEIN LLP, 125 SUMMER STREET, BOSTON, MA, 02110-1618, US

(21) Appl. No.: 10/532,154

(22) PCT Filed: Oct. 9, 2003
(86) PCT No.: PCT/GB03/04392

§ 371 Date: Nov. 21, 2005

(30) Foreign Application Priority Data
Oct. 22, 2002 (GB) 0224490.3

(51) Int. Cl. G01N 19/00

(52) U.S. Cl. 73/865.9

(57) ABSTRACT

An integrated sweep kit provides for the detection and location of covert electronic eavesdropping devices of both the radiating type (ie. transmitting electromagnetic energy) and the non-radiating type (ie. not transmitting electromagnetic energy). The kit includes at least one non-radiating device sensor for actively transmitting a detection signal, which detection signal is adapted to trigger a response from a normally non-radiating device; and at least one radiating device sensor for passively receiving a signal generated by a radiating device. A synchronization means is used for consecutively activating operation of the non-radiating device sensor and the radiating device sensor during sequential time slots so that the sensors do not interfere with one another.

The present invention relates to methods and apparatus for detecting and locating covert electronic eavesdropping devices, and in particular to methods and apparatus for detecting devices of the radiating type (ie. transmitting electromagnetic energy) and for detecting devices of the non-radiating type (ie. not normally transmitting electromagnetic energy).

Where the threat of electronic espionage exists it is common practice to clear and secure sensitive locations by performing a Technical Surveillance Counter Measures (TSCM) Sweep.

Part of any TSCM sweep includes using electronic counter surveillance equipment to detect and locate covert eavesdropping devices.

Typical electronic counter surveillance equipment may include counter surveillance radio receivers (e.g. harmonic receivers, spectrum analysers, scanners etc.), broadband radio detectors, Non-Linear Junction Detectors (NLJDs) and radio jammers.

In the prior art, a TSCM operator has to separately deploy different types of counter surveillance equipment to effectively combat the wide and varied threat posed by electronic eavesdropping devices.

By way of example, the counter surveillance radio receiver is ideally suited for the detection of continuously radiating eavesdropping devices, while the broadband radio detector is ideally suited to the detection of intermittently radiating eavesdropping devices and the Non-Linear Junction detector is ideally suited to the detection of non-radiating eavesdropping devices.

For every separate piece of detection equipment used, a time consuming sweep process must be repeated. Each sweep process effectively comprises sequentially examining a plurality of points or regions in space, possibly also each at a plurality of possible detection angles. Therefore, repeating the sweep pattern for each of a plurality of detector types is time consuming and inefficient.

Thus there is a need for a method and apparatus which can combine the constituent parts of a TSCM sweep into a single, integrated real-time operation and thus reduce the time required to perform the sweep operation.

In the prior art, the TSCM operator has to rely on limited information from a single item of counter surveillance equipment when analysing the potential threat of any encountered target. Basing a decision on limited information can cause targets to be missed or mis-identified (false alarms).

Mis-identification of targets can increase the time taken to perform a sweep, whereas missing a target is obviously undesirable.

Thus there is a need for a method and apparatus that facilitates the combining and processing of information from a plurality of sources so as to provide the TSCM operator with a more accurate threat assessment of potential eavesdropping targets.

In the prior art, counter surveillance equipment is designed with dedicated signal demodulators and dedicated signal detectors to aid the signal analysis process. As electronic eavesdropping devices become more sophisticated many of the dedicated demodulators and detectors become less useful to the TSCM operator.

Thus there is a need for an apparatus whose signal analysis capability can be easily adapted/modified as more sophisticated eavesdropping devices become available.

In the prior art, where a large physical area is to be cleared and secured during the TSCM sweep it is impossible to simultaneously deploy a number of TSCM operators using different types of electronic counter surveillance equipment without suffering from mutual interference between the various items of detection equipment.

By way of example, a counter surveillance receiver will detect and hence suffer interference from any NLJD, which is operated in the same location at the same time.

Thus there is a further need for an apparatus which can co-exist with other similar types of apparatus without suffering from mutual interference.

One object of the present invention is to reduce the time required to perform a TSCM sweep.

Another object of the present invention is to allow the TSCM sweep to be performed in real-time.

A still further object of the present invention is to reduce the chances of missing or mis-identifying an eavesdropping target during the TSCM sweep.

A still further object of this invention is to allow the signal analysis capabilities of the single unit (signal detectors/signal demodulators etc.) to be adaptable so as to cover future trends in eavesdropping device technology.

A yet further object of the present invention is to allow a plurality of integrated single units to co-exist and operate without suffering from mutual interference.

According to one aspect, the present invention provides an apparatus for detecting radiating and non-radiating electronic devices, comprising:
at least one non-radiating device sensor for actively transmitting a detection signal which detection signal is adapted to trigger a response from a normally non-radiating device;
at least one radiating device sensor for passively receiving a signal generated by a radiating device; and
synchronisation means for consecutively activating operation of the non-radiating device sensor and the radiating device sensor during sequential time slots.

According to another aspect, the present invention provides an apparatus for detecting radiating electronic devices, comprising:
at least one radiating device sensor for passively receiving a signal generated by a radiating device;
communication means for communication with at least one remote non-radiating device sensor which sensor actively transmits a detection signal to trigger a response from a normally non-radiating device; and
synchronisation means for consecutively activating operation of the remote non-radiating device sensor and the local radiating device sensor during sequential time slots.

According to another aspect, the present invention provides an apparatus for detecting non-radiating electronic devices, comprising:
at least one non-radiating device sensor for actively transmitting a detection signal to trigger a response from a normally non-radiating device;
communication means for communication with at least one remote radiating device sensor which sensor passively receives a signal generated by a radiating device; and
synchronisation means for consecutively activating operation of the local non-radiating device sensor and the remote radiating device sensor during sequential time slots.

According to another aspect, the present invention provides a method of detecting radiating and non-radiating electronic devices, comprising the steps of:
activating at least one non-radiating device sensor that actively transmitting a detection signal which detection signal is adapted to trigger a response from a normally non-radiating device;
activating at least one radiating device sensor for passively receiving a signal generated by a radiating device; and
synchronising the activation of the non-radiating device sensor and the radiating device sensor for consecutive operation of the non-radiating device sensor and the radiating device sensor during sequential time slots.

According to another aspect, the present invention provides an apparatus for detecting radiating and non-radiating electronic devices, comprising any two or more of the following non-radiating device sensors and radiating device sensors and their associated detectors, selected from:
a non-linear junction detector/radio jammer; a metal detector, a harmonic receiver, a broadband detector, a spectrum analyser, a single and/or multiple frequency receiver, a frequency counter, a cable checker;
the non-radiating device sensors for actively transmitting a detection signal which detection signal is adapted to trigger a response from a normally non-radiating device and the radiating device sensors for passively receiving a signal generated by a radiating device; and
synchronisation means for enabling consecutive activation and operation of any non-radiating device sensors/detectors and radiating device sensors/detectors during sequential time slots.

The present invention provides an apparatus which integrates a plurality of different types of counter surveillance equipment into a single unit, whereby the constituent parts of the integrated single unit can then be operated, and their outputs interrogated and combined, in a simultaneous, synchronous, or asynchronous manner.

In order to achieve the foregoing objects, the present invention preferably integrates a number of items of electronic counter-surveillance equipment into a single physical housing.

The constituent parts of the integrated unit may then be operated in a simultaneous, synchronous, or asynchronous manner to effectively reduce the required sweep time.

By the expression “simultaneous”, we mean that any detectors within the integrated unit that do not cause mutual interference are active and interrogated at the same time. By the expression “synchronous”, we mean that any detectors that do cause mutual interference are activated and interrogated at different times. By the expression “asynchronous”, we mean that, where required, any of the detectors can be operated on their own, in a dedicated non-integrated mode.

During the integrated real-time sweep, the outputs from the constituent parts are monitored and combined to reduce the possibility of missed targets or false alarms.

As future trends dictate, the signal analysis capabilities of the single unit may be modified by means of an adaptable personality module. The personality module may be upgraded via replacement or upload from the network connection of the single unit.

Where a large area is to be swept, a network connection may allow a plurality of single units to be synchronised and thus avoid mutual interference.

Embodiments of the present invention will now be described by way of example and with reference to the accompanying drawings in which:

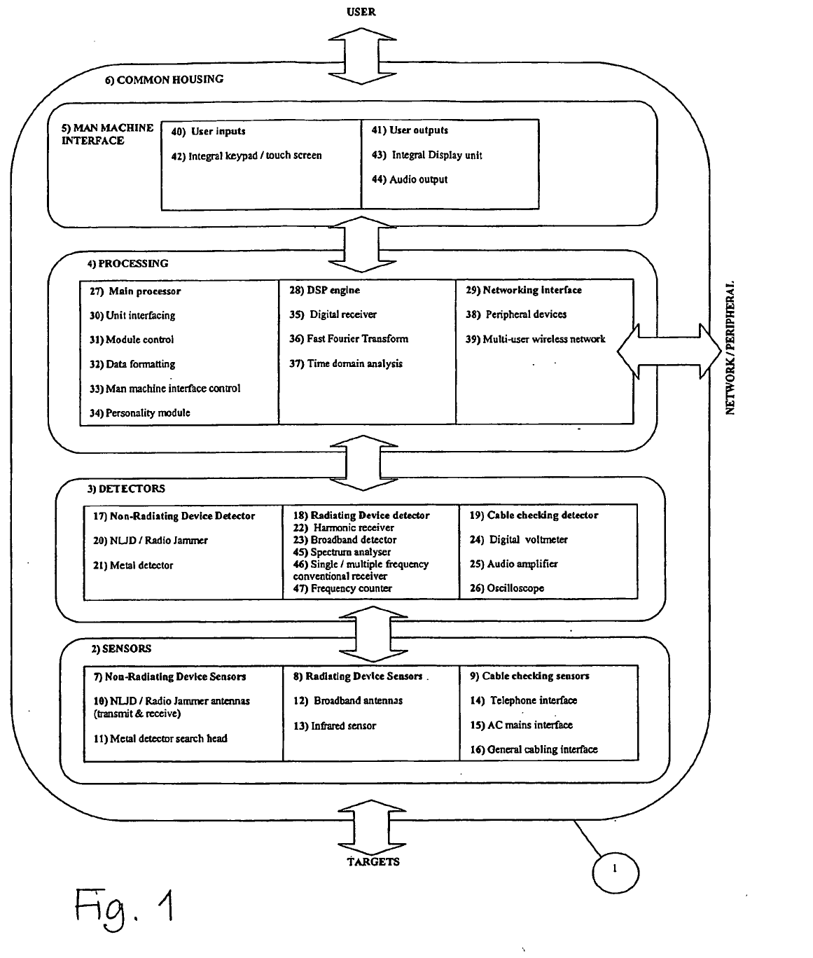

FIG. 1 is a schematic block diagram of the integrated sweep kit; and

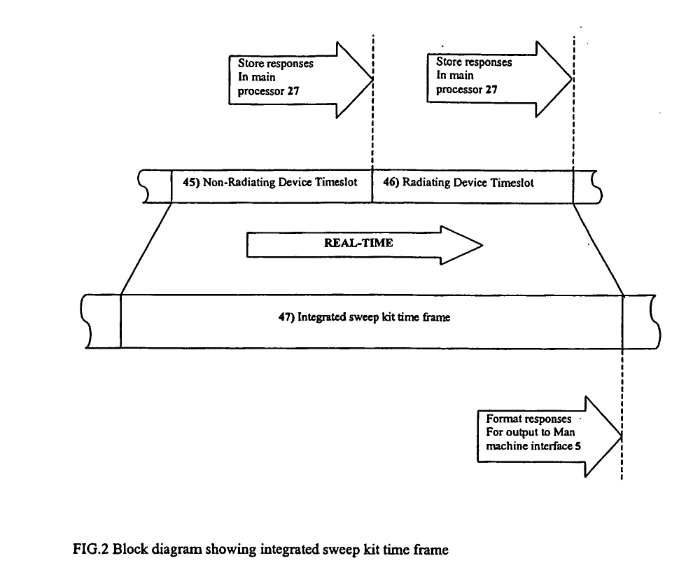

FIG. 2 is a schematic block diagram showing temporal operation of the integrated sweep kit.

Referring to FIG. 1, an integrated sweep kit apparatus of the present invention is indicated at 1, and includes sensors 2, detectors 3, processors 4, and a man machine interface 5 all housed in a common enclosure 6.

The sensors 2 include non-radiating device sensors 7 (ie those sensors which actively emit radiation in their attempt to detect normally non-radiating devices). The sensors 2 also include radiating device sensors 8 (ie. those sensors which passively “listen” for radiation emitted by the radiating devices. The sensors may also include cable checking sensors 9.

The non-radiating device sensors 7 may include, inter alia, transmit and receive antennas for a NLJD and/or radio jammer 10, and a search head for the metal detector 11.

The radiating device sensors 8 may include, inter alia, broadband antennas 12 for radiating device detectors 18 and infra red sensors 13.

The cable checking sensors 9 may include, inter alia, interfaces to telephone systems 14, interfaces to AC mains cabling 15 and general cabling interfaces 16.

Cable checking sensors may be of the active or passive types, ie. those which actively drive signals onto the cables to establish properties thereof, or those which passively sense cable properties such as current flow, voltage, or the like. Therefore, a cable checking sensor 9 may fall into the category of non-radiating device sensor or radiating device sensor, depending upon the type and application.

The detectors 3 include non-radiating device detectors 17 coupled to the non-radiating device sensors 7. The detectors 3 also include radiating device detectors 18 coupled to the radiating device sensors 8. The detectors may include cable checking detectors 19 coupled to the cable checking sensors 9.

The non-radiating device detectors 17 may include, inter alia, any of a NLJD and/or radio jammer 20 and a metal detector 21.

The radiating device detectors 18 may include, inter alia, any of a harmonic receiver 22, a broadband detector 23, a spectrum analyser 45, a single or multiple frequency receiver 46, or a frequency counter 47.

The cable checking detectors 19 may include, inter alia, any of a digital voltmeter 24, an audio amplifier 25, an oscilloscope 26, and a time domain reflector.

The processor 4 may include a main processor 27, a digital signal processing (DSP) engine 28, and a networking interface 29.

The main processor 27 performs a number of possible functions. These may include unit interfacing functions 30 for providing an interface of the unit 1 with external devices, such as data logging devices, networks, other sweep kits and the like. The main processor 27 also performs module control functions 31 for controlling the activities of the various detectors 17, 18, 19 and sensors 7, 8, 9. The main processor 27 may also provide data formatting functions 32 for providing data output to external devices. The main processor 27 may also provide man machine interface control functions 33 for controlling the man machine interface devices to be described later. The main processor 27 may also hold a personality module 34 which determines modes of operation of the integrated unit 1. These modes of operation may determine detector control and signal analysis required for different types of sweep, for different types of environment, and/or for different configurations or combinations of detectors/sensors.

More specifically, the personality module 34 may define a Man Machine Interface (MMI) and the detection capability of the apparatus. By changing the personality module (software) it is possible to upgrade or modify the apparatus specification to meet specific user requirements, depending upon the specific TSCM sweeps required.

The DSP engine 28 may comprise a digital receiver 35 for the NLJD 20 and may perform Fast Fourier Transforms 36 for real time analysis of outputs from the harmonic receiver 22 output. The DSP engine may also perform time domain analysis 37 on the output of the broadband detector 23.

The networking interface 29 allows the unit to be connected to various peripheral devices 38 e.g. modems, printers, laptops etc. as well as allowing simultaneous use of a plurality of integrated sweep kit units via a wireless network connection 39.

The man machine interface 5 may include user input devices 40 and user output devices 41. The user input devices 40 may comprise one or more of an integral keypad and touch screen 42, or remote control devices coupled via the networking interface 29.

The user output devices may include one or more of an integral display unit 43, audio outputs 44, and remote devices coupled via the networking interface 29.

Referring to FIG. 2, when the unit is operating in a fully synchronous integrated mode the detectors 3 will be controlled by the processor 4 to operate in a synchronous manner that prevents the non-radiating device sensors and detectors (ie. those that are active in the sense that they transmit detection signals in order to trigger responses from normally non-radiating devices) from causing interference with, or erroneous signals to be derived from, the radiating device sensors and detectors (ie. those that are passive in the sense that they do not transmit detection signals to trigger responses from devices, but rely on inherent emissions from the radiating devices).

Thus, in this manner, the processor 4 prevents the NLJD or radio jammer 20 transmit section from interfering with the harmonic receiver 22 or the broadband detector 23. More generally, synchronous operation ensures that simultaneous operation of detectors that would interfere with one another is prevented.

Each non-radiating device sensor that may interfere with a radiating device sensor, or indeed with another different non-radiating device sensor, is allocated a time slot 45 in which it may be active.

At the end of the non-radiating device sensor time slot 45, responses from the relevant sensor or sensors will be stored in the main processor 27 for subsequent processing, combining and/or formatting.

The radiating device sensors (ie. those which are “passive”) are allocated a subsequent time slot 46 in which, for example, the harmonic receiver 22 and the broadband detector 23 may be operational. Generally, the radiating device sensors will not interfere with one another and may all be operational during the time slot 46, ie. their operation may be simultaneous.

At the end of the radiating device sensor time slot 46, responses from the relevant sensors and detectors, such as harmonic receiver 22 and broadband detector 23 will be stored in the main processor 27 for subsequent processing, combining and formatting.

It will be understood that one or more non-radiating device sensor time slots 45 and one or more radiating device sensor time slots 46 are allocated sequentially on a cyclical, continuous or intermittent basis. For example, the time slots may be contiguous or there may be a brief quiescent period between.

By virtue of the allocation of time slots, the processor 4 effectively acts as a synchronisation means for consecutively activating operation of at least one non-radiating device sensor and at least one radiating device sensor, during sequential time slots.

A complete sweep may occupy a time frame 47 of indeterminate length, comprising as many time slots 45, 46 as required to complete the spatial extent of the sweep.

The length of each time slot may be adapted to suit the particular sensing/detection operation taking place. For example, the time slot for a non-radiating device sensor need not be the same as for a radiating device sensor. In a preferred embodiment, the combined time of one slot for each of the different sensors (ie. one full cycle time) is around 0.25 seconds, so that each sensor is activated four times per second. However, this may be varied according to the requirements of the TSCM sweep.

In some circumstances, it may be desirable for one sensor to be allocated two separate time slots within one full cycle of sensor time slots.

In a preferred arrangement, the cycle time of the time slots (and thus the duration of each time slot) is adapted such that the users notice no, or very little, difference in the speed with which they must manipulate the integrated sweep kit around a predetermined sweep path, as compared to the speed with which a single sensor device would be operated. To this end, in a preferred configuration, a maximum of 1 to 2 seconds per time slot is envisaged, or a maximum time for one cycle of about 5 to 10 seconds, depending upon the number of sensors in use.

At the end of the integrated sweep kit time frame 47, the main processor 27 will format the responses obtained during the timeslots 45 and 46 to produce an output to the operator via the man machine interface 5.

Alternatively, the processor may continually update responses based on outputs received during the non-radiating device sensor time slots 45 and the radiating device sensor time slots 46, in real time.

Preferably, the personality module 34 includes control code for determining the allocation of time slots to the available sensors and detectors depending upon the sensors and detectors available in the integrated sweep kit 1, and depending upon a selected type of sweep required.

Outputs from the different detectors may be combined and analysed using artificial intelligence techniques such as decision trees, rule based logic and fuzzy logic to form a decision whereby a target can be accurately and reliably identified. As new eavesdropping devices are developed, new rules can be learnt by the equipment, or new rules can be added to the equipment.

The outputs from the different detectors can also be combined and analysed using artificial intelligence techniques such as pattern recognition. The outputs from each target will form a pattern, which can then be used as the target's signature, allowing the target to be identified. As new eavesdropping devices are developed the artificial intelligence can learn to identify and create new signatures or new signatures can be added to the equipment.

Although the preferred embodiment of FIG. 1 shows the various detectors and sensors housed in a common enclosure, it will be recognised that the various sensors, detectors and processors could be distributed, ie. deployed in a plurality of separate, discrete housings. In this instance, each separately housed part of the sweep kit apparatus 1 includes a synchronisation controller that allows each part to communicate with the other parts to ensure that each part is permitted to operate only in its allocated time slot 45, 46 to ensure that there is no collision or interference between the parts.

Although the preferred mode of operation of the integrated sweep kit is for synchronous operation of the non-radiating device sensors and the radiating device sensors, it will be understood that the apparatus may also be configured to operate in an asynchronous mode, in which any single sensor and detector is enabled to operate alone in a dedicated mode. This may be advantageous, particularly after an initial synchronous sweep using multiple sensors, to provide optimum data on potential target identified in the synchronous sweep.

Other embodiments are intentionally within the scope of the accompanying claims.

1-18. (canceled)

19. Apparatus for detecting radiating and non-radiating electronic devices, comprising:
at least one non-radiating device sensor for actively transmitting a detection signal which detection signal is adapted to trigger a response from a normally non-radiating device;
at least one radiating device sensor for passively receiving a signal generated by a radiating device; and
at least one controller for consecutively activating operation of the at least one non-radiating device sensor and the at least one radiating device sensor during sequential time slots.

20. The apparatus of claim 19 in which the at least one non-radiating device sensor includes a transmit/receive antenna for detection of metals and/or semiconductors.

21. The apparatus of claim 19 in which the at least one non-radiating device sensor includes a cable checking sensor.

22. The apparatus of claim 19 in which the at least one radiating device sensor includes any one or more of:
a receive antenna for detection of radiating devices;
an infra red sensor; and
a cable checking sensor for detection of electrical and/or electromagnetic signals on a cable.

23. The apparatus of claim 19 further including a non-radiating device detector coupled to the at least one non-radiating device sensor.

24. The apparatus of claim 19 further including at least one radiating device detector coupled to the at least one radiating device sensor.

25. The apparatus of claim 24 in which the at least one radiating device detector includes a harmonic receiver.

26. The apparatus of claim 24 in which the at least one radiating device detector comprises a broadband receiver.

27. The apparatus of claim 24 in which the at least one radiating device detector comprises any one or more of a digital voltmeter, an audio amplifier and an oscilloscope.

28. The apparatus of claim 19 further including a digital signal processor for processing signals output from any one or more of the at least one non-radiating device sensor and the at least one radiating device sensor.

29. The apparatus of claim 19 housed in a single portable casing.

30. The apparatus of claim 19 including said at least one radiating device sensor and at least two said non-radiating device sensors, the at least one controller allocating different time slots to each of the non-radiating device sensors and to the at least one radiating device sensor.

31. The apparatus of claim 19 in which the at least one radiating device sensor is provided in a first housing having a first controller, and the at least one non-radiating device sensor is provided in a second housing having a second controller, and in which the controllers are in communication with one another for coordinating said consecutively activated operation of the at least one non-radiating device sensor and the at least one radiating device sensor during sequential time slots.

32. Apparatus for detecting radiating electronic devices, comprising:
at least one radiating device sensor for passively receiving a signal generated by a radiating device;
a controller, in communication with at least one remote non-radiating device sensor which sensor actively transmits a detection signal to trigger a response from a normally non-radiating device, for consecutively activating operation of the remote non-radiating device sensor and the local radiating device sensor during sequential time slots.

33. Apparatus for detecting non-radiating electronic devices, comprising:
at least one non-radiating device sensor for actively transmitting a detection signal to trigger a response from a normally non-radiating device;
a controller, in communication with at least one remote radiating device sensor which sensor passively receives a signal generated by a radiating device, for consecutively activating operation of the local non-radiating device sensor and the remote radiating device sensor during sequential time slots.

34. A method of detecting radiating and non-radiating electronic devices, comprising:
activating at least one non-radiating device sensor that actively transmits a detection signal which detection signal is adapted to trigger a response from a normally non-radiating device;
activating at least one radiating device sensor for passively receiving a signal generated by a radiating device; and
automatically synchronizing the activation of the non-radiating device sensor and the radiating device sensor for consecutive operation of the non-radiating device sensor and the radiating device sensor during sequential time slots.

35. Apparatus for detecting radiating and non-radiating electronic devices, comprising any two or more of the following non-radiating device sensors and radiating device sensors and their associated detectors, selected from:
a non-linear junction detector/radio jammer; a metal detector, a harmonic receiver, a broadband detector, a spectrum analyser, a single and/or multiple frequency receiver, a frequency counter, a cable checker;
the non-radiating device sensors for actively transmitting a detection signal which detection signal is adapted to trigger a response from a normally non-radiating device and the radiating device sensors for passively receiving a signal generated by a radiating device; and
synchronization means for enabling consecutive activation and operation of any non-radiating device sensors/detectors and radiating device sensors/detectors during sequential time slots.

36. Apparatus for detecting radiating and non-radiating electronic devices, comprising:
at least one non-radiating device sensor for actively transmitting a detection signal which detection signal is adapted to trigger a response from a normally non-radiating device;
at least one radiating device sensor for passively receiving a signal generated by a radiating device; and
synchronization means for consecutively activating operation of the at least one non-radiating device sensor and the at least one radiating device sensor during sequential time slots.

37. The apparatus of claim 36, wherein the at least one non-radiating device sensor includes means for receiving a response from the normally non-radiating device.

38. The apparatus of claim 36 further including digital signal processing means for processing signals output from any one or more of the at least one non-radiating device sensor and the at least one radiating device sensor.
